(19) United States
(12) Patent Application Publication
(10) Pub. No.: US 2024/0173579 A1
(43) Pub. Date: May 30, 2024

(54) SYSTEM AND METHOD FOR EXTINGUISHING FIRE OF HIGH VOLTAGE BATTERY FOR VEHICLE

(71) Applicants: Hyundai Motor Company, Seoul (KR); Kia Corporation, Seoul (KR)

(72) Inventor: Young-Bin JEONG, Suwon-si (KR)

(73) Assignees: Hyundai Motor Company, Seoul (KR); Kia Corporation, Seoul (KR)

(21) Appl. No.: 18/242,404

(22) Filed: Sep. 5, 2023

(30) Foreign Application Priority Data
Nov. 25, 2022 (KR) 10-2022-0160750

(51) Int. Cl. A62C 3/07; A62C 37/40; B60L 50/64

(52) U.S. Cl. CPC A62C 3/07; A62C 37/40; B60L 50/64

(57) ABSTRACT

A system and a method for extinguishing a fire of a high voltage battery for a vehicle, which supply a fire-extinguishing liquid to a fire extinguishing case in a form of a container when a fire occurs in a high voltage battery provided in a vehicle, submerging the high voltage battery in the fire-extinguishing liquid, include a battery cell assembly, a fire extinguishing case to accommodate the battery cell assembly, a fire-extinguishing liquid tank connected to the fire extinguishing case, wherein a fire-extinguishing liquid is stored in the fire-extinguishing liquid tank, a supply valve provided between the fire-extinguishing liquid tank and the fire extinguishing case and configured to supply or block the fire-extinguishing liquid from the fire-extinguishing liquid tank to the fire extinguishing case, and a controller electrically connected to the supply valve and configured to open the supply valve to supply the fire-extinguishing liquid to the fire extinguishing case when the controller concludes that the fire occurs in the battery cell assembly.

### CROSS-REFERENCE TO RELATED APPLICATION

The present application claims priority to Korean Patent Application No. 10-2022-0160750, filed on Nov. 25, 2022, the entire contents of which is incorporated herein for all purposes by this reference.

### BACKGROUND OF PRESENT DISCLOSURE

### Field of Present Disclosure

The present disclosure relates to a system and a method for extinguishing a fire of a high voltage battery for a vehicle, which supply a fire-extinguishing liquid to a fire extinguishing case in a form of a container when a fire occurs in a high voltage battery provided in a vehicle, submerging the high voltage battery in the fire-extinguishing liquid.

### Description of Related Art

Recently, due to the electrification of vehicles, the supply of eco-friendly vehicles provided with high voltage batteries, such as electric vehicles, is rapidly expanding.

Because the high voltage battery is charged with electrical energy at a high density and is made by stacking cells, in which an anode, a cathode, an electrolyte, and separators are provided, to be formed in a form of a battery pack, when a fire occurs in the high voltage battery, there is a problem in that it is not easy to extinguish the fire.

An aspect of the fire occurring in the high-voltage battery is that a fire, when a fire occurs in any one cell, rapidly spreads to other adjacent cells and burns until the high voltage battery is entirely burnt out.

Generally, a method of extinguishing a fire in a high voltage battery is to spray water until the fire is extinguished. However, because cells are stacked inside a high voltage battery case, water sprayed from the outside thereof does not easily reach the inside of the high voltage battery case, and thus it is difficult to actually extinguish the fire. Accordingly, the fire in the high voltage battery may proceed for several tens of hours.

To solve the above problem, a prefabricated water tank is provided around a vehicle, and the water tank is filled with water to submerge the high voltage battery in water so that the fire is extinguished. However, there is a problem in that it is not easy to install the prefabricated water tank around the vehicle where the fire occurs.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY OF PRESENT DISCLOSURE

Various aspects of the present disclosure are directed to providing a system and a method for extinguishing a fire of a high voltage battery for a vehicle, which provide a separate fire extinguishing case accommodating a battery pack for fire extinguishing of the battery pack and supply a stored fire-extinguishing liquid, when a fire is detected, to inside of the fire extinguishing case to submerge a high voltage battery in the fire-extinguishing liquid.

Other objects and advantages of the present disclosure may be understood by the following description and become apparent with reference to the exemplary embodiments of the present disclosure. Also, it is obvious to those skilled in the art to which the present disclosure pertains that the objects and advantages of the present disclosure may be realized by the means as claimed and combinations thereof.

In accordance with an exemplary embodiment of the present disclosure, there is provided a system for extinguishing a fire of a high voltage battery for a vehicle, which includes a battery cell assembly, a fire extinguishing case to accommodate the battery cell assembly, a fire-extinguishing liquid tank connected to the fire extinguishing case, wherein a fire-extinguishing liquid is stored in the fire-extinguishing liquid tank, a supply valve provided between the fire-extinguishing liquid tank and the fire extinguishing case and configured to supply or block the fire-extinguishing liquid from the fire-extinguishing liquid tank to the fire extinguishing case, and a controller electrically connected to the supply valve and configured to open the supply valve to supply the fire-extinguishing liquid to the fire extinguishing case when the controller concludes that the fire occurs in the battery cell assembly.

A supply pipe may be provided to connect the fire-extinguishing liquid tank to the fire extinguishing case so that the fire-extinguishing liquid may be supplied from the fire-extinguishing liquid tank to the fire extinguishing case, and the supply valve may be provided at the supply pipe.

A pump may be provided at the supply pipe to pressurize the fire-extinguishing liquid and supply the fire-extinguishing liquid to the fire extinguishing case.

The supply pipe may be connected to an external supply line which supplies a fire-extinguishing liquid or water from the outside thereof, between the supply valve and the fire-extinguishing liquid tank.

A discharge pipe may be connected to the fire extinguishing case to discharge a liquid inside the fire extinguishing case to the outside thereof, a discharge valve may be provided at the discharge pipe, and the controller may close the discharge valve when a fire of the battery cell assembly is detected.

Each of the supply valve and the discharge valve may be a check valve.

The system may further include a sensor configured to detect the fire of the battery cell assembly and output a fire detection signal to the controller.

The sensor may be a temperature sensor configured for measuring a temperature of the battery cell assembly.

The sensor may be an off-gas sensor configured to detect a gas generated from the battery cell assembly during thermal runaway.

The system may further include an upper case which closes an upper portion of the fire extinguishing case.

In accordance with another exemplary embodiment of the present disclosure, there is provided a method of extinguishing a fire of a high voltage battery for a vehicle, which includes a battery temperature comparison step of determining, by a controller, whether a temperature of a battery cell assembly is higher than or equal to a thermal runaway temperature, an off-gas detecting step of determining whether an off-gas is generated from the battery cell assembly, a supply valve opening step of opening a supply valve provided between a fire-extinguishing liquid tank and a fire extinguishing case which accommodates the battery cell assembly, and a battery submerging step of increasing a liquid level of a fire-extinguishing liquid to be higher than a top surface of the battery cell assembly.

The method may further include, before the battery temperature comparison step, a sensor start-up step of inputting an output value of a temperature sensor configured for measuring the temperature of the battery cell assembly and an output value of an off-gas sensor configured to detect the off-gas generated from the battery cell assembly to the controller.

In the battery temperature comparison step and the off-gas detecting step, the off-gas detecting step may be performed first, and the battery temperature comparison step may be performed.

The method may further include, before the supply valve opening step, a discharge valve closing step of closing, by the controller, a discharge valve.

When it is determined that the temperature of the battery cell assembly not higher than or equal to the thermal runaway temperature in the battery temperature comparison step, the battery temperature comparison step may be repeatedly performed.

When the generation of the off-gas is not detected in the off-gas detecting step, the off-gas detecting step may be repeatedly performed.

The method may further include, after the battery submerging step, a fire extinguishing completion determining step of determining whether the fire of the battery cell assembly is extinguished, and when it is determined that the fire of the battery cell assembly is not extinguished, an external supplying step of additionally supplying a fire-extinguishing liquid or water from the outside to the fire extinguishing case.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is an exploded perspective view exemplarily illustrating a system for extinguishing a fire of a high voltage battery for a vehicle according to an exemplary embodiment of the present disclosure.

FIG. 2 is an exploded perspective view exemplarily illustrating a system for extinguishing a fire of a high voltage battery for a vehicle according to another exemplary embodiment of the present disclosure.

FIG. 3 is a schematic diagram illustrating a state in which the system for extinguishing a fire of a high voltage battery for a vehicle according to another exemplary embodiment of the present disclosure performs control in an ordinary situation.

FIG. 4 is a schematic diagram illustrating a state in which the system for extinguishing a fire of a high voltage battery for a vehicle according to another exemplary embodiment of the present disclosure performs control when a fire occurs.

FIG. 5 is a schematic diagram illustrating a state in which the system for extinguishing a fire of a high voltage battery for a vehicle according to another exemplary embodiment of the present disclosure supplies a fire-extinguishing liquid or water from the outside thereof when a fire occurs.

FIG. 6 is a flowchart illustrating a method of extinguishing a fire of a high voltage battery for a vehicle according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a system and a method for extinguishing a fire of a high voltage battery for a vehicle according to an exemplary embodiment of the present disclosure will be described in detail with reference to the accompanying drawings.

A system for extinguishing a fire of a high voltage battery for a vehicle according to an exemplary embodiment of the present disclosure includes a battery cell assembly 11, a fire extinguishing case 13, 20 formed in a form of a container and configured to accommodate the battery cell assembly 11, a fire-extinguishing liquid tank 21 in which a fire-extinguishing liquid is stored, a supply valve 23 provided between the fire-extinguishing liquid tank 21 and the fire extinguishing case 13, 20 and configured to supply or block the fire-extinguishing liquid from the fire-extinguishing liquid tank to the fire extinguishing case, and a controller 40 electrically connected to the supply valve 23 and configured to open the supply valve 23 to supply the fire-extinguishing liquid to the fire extinguishing case 13, 20 when detecting that a fire occurs in the battery cell assembly 11.

Hereinafter, because the battery pack 10 includes battery cell assembly 11, a description of the battery cell assembly 11 includes a description of a battery pack 10.

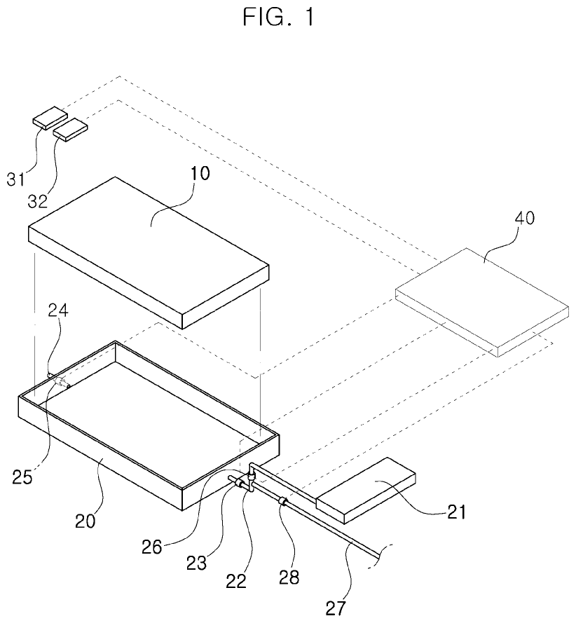

In an exemplary embodiment of the present disclosure, as shown in FIG. 1, a battery pack 10 or a battery cell assembly 11 is accommodated inside the fire extinguishing case 20 which accommodates the fire-extinguishing liquid when the fire-extinguishing liquid is supplied due to a fire.

The fire extinguishing case 20 is formed in a form of a container configured for accommodating the fire-extinguishing liquid therein rather than simply covering a lower portion of the battery cell assembly 11. Thus, when the fire-extinguishing liquid is supplied in the event of a fire, the fire extinguishing case 20 is configured as a water tank which completely submerges the battery cell assembly 11 in the fire-extinguishing liquid.

The fire-extinguishing liquid tank 21 stores therein the fire-extinguishing liquid for extinguishing a fire occurring in the battery cell assembly 11. When a fire of the battery cell assembly 11 is detected by the controller 40, the fire-extinguishing liquid is supplied for fire extinguishing.

The supply valve 23 is provided between the fire-extinguishing liquid tank 21 and the fire extinguishing case 20 and supplies or blocks the fire-extinguishing liquid. A supply pipe 22 connecting the fire-extinguishing liquid tank 21 to the fire extinguishing case 20 is provided to allow the fire-extinguishing liquid tank 21 to supply the fire-extinguishing liquid from the fire-extinguishing liquid tank 21 to the fire extinguishing case 20, and the supply valve 23 is provided at the supply pipe 22.

The supply valve 23 is provided as a check valve, is opened to allow the fire-extinguishing liquid to be supplied from the fire-extinguishing liquid tank 21 to the fire extinguishing case 20 when a fire is detected, and is maintained in a closed state in an ordinary situation.

The fire-extinguishing liquid tank 21 is located higher than the fire extinguishing case 20, and thus the fire-extinguishing liquid may flow naturally.

Meanwhile, a pump 26 electrically connected to the controller 40 may be provided at the supply pipe 22 to pressurize and supply the fire-extinguishing liquid to the fire extinguishing case 20. When a fire occurs in the battery cell assembly 11, because the fire proceeds rapidly due to thermal runaway, the fire-extinguishing liquid is supplied through the pump 26 so that the fire-extinguishing liquid may be supplied rapidly.

Furthermore, an external supply line 27 is connected to the supply pipe 22. When the fire-extinguishing liquid stored in the fire-extinguishing liquid tank 21 is insufficient, the external supply line 27 supplies a fire-extinguishing liquid or water from the outside thereof to the fire extinguishing case 20. An external supply valve 28 is provided at the external supply line 27 to open or close the external supply line 27. The external supply valve 28 is opened only when the fire-extinguishing liquid or water is supplied from the outside thereof through the external supply line 27.

A discharge pipe 24 for discharging liquid, for example the fire-extinguishing liquid or the water, inside the fire extinguishing case 20 is formed on one side of the fire extinguishing case 20, and a discharge valve 25 is provided at the discharge pipe 24. The discharge valve 25 is opened in an ordinary situation to allow moisture inside the fire extinguishing case 20 to be discharged to the outside and is closed in the event of a fire so that the fire-extinguishing liquid of the fire extinguishing case 20 is not discharged and remains inside the fire extinguishing case 20. The discharge valve 25 is provided as a check valve to discharge moisture or liquid of the fire extinguishing case 20 to the outside. When a fire occurs in the battery cell assembly 11, the discharge valve 25 is closed, and thus the fire extinguishing case 20 is filled with the fire-extinguishing liquid. When the fire extinguishing case 20 is filled with the fire-extinguishing liquid, the battery cell assembly 11 is blocked from air and rapidly cooled so that the fire may be extinguished at an early stage.

Sensors 31 and 32 for detecting a fire of the battery cell assembly 11 are provided.

An example of the sensor may be a temperature sensor 31 configured for measuring a temperature of the battery cell assembly 11. The temperature sensor 31 is provided at one side of the fire extinguishing case 20 and measures a temperature of the battery cell assembly 11.

Furthermore, the sensor may be an off-gas sensor 32 for detecting an off-gas generated when a fire occurs in the battery cell assembly 11.

The controller 40 is configured to determine whether a fire occurs in the battery cell assembly 11 based on values input from the temperature sensor 31 and the off-gas sensor 32. When it is determined that a fire occurs in the battery cell assembly 11, the controller 40 is configured to control the supply valve 23 and the discharge valve 25 to allow the fire extinguishing case 20 to be filled with the fire-extinguishing liquid of the fire-extinguishing liquid tank 21. That is, when the fire is detected, the controller 40 opens the supply valve 23 to supply the fire-extinguishing liquid and closes the discharge valve 25 to allow the fire-extinguishing case 20 to be filled with the fire-extinguishing liquid. To determine whether the fire occurs in the battery cell assembly 11, the controller 40 may use both output values of the temperature sensor 31 and the off-gas sensor 32 to prevent malfunction.

In the instant case, the controller 40 operates the pump 26 to accelerate the supply of the fire-extinguishing liquid.

Furthermore, when the fire in the battery cell assembly 11 is not extinguished using only the fire-extinguishing liquid in the fire-extinguishing liquid tank 21, the controller 40 opens the external supply valve 28 to allow a fire-extinguishing liquid or water to be supplied from the outside.

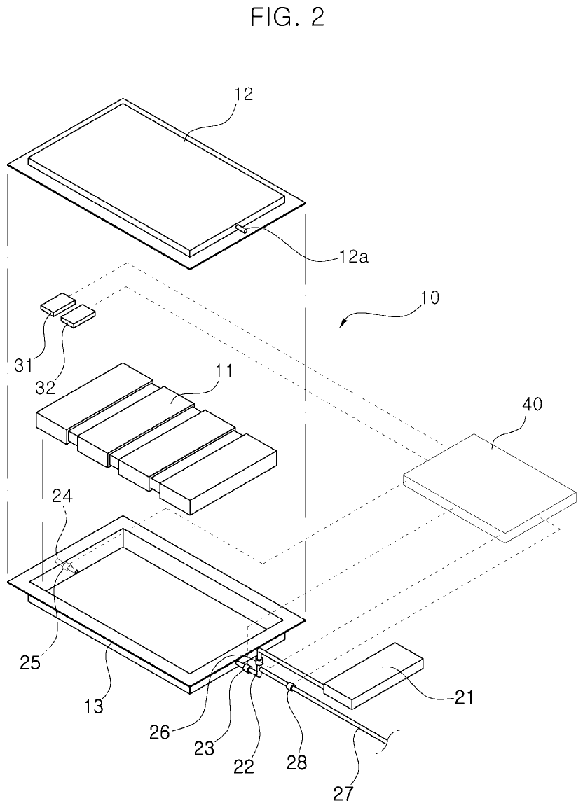

FIG. 2 shows an example in which an upper case 12 is provided at an upper portion the fire extinguishing case 13 according to another exemplary embodiment of the present disclosure. The upper case 12 is fastened to the fire extinguishing case 13 to close the upper portion of the fire extinguishing case 13. A space formed due to the fastening between the upper case 12 and the fire extinguishing case 13 accommodates the battery cell assembly 11 and becomes a space filled with the fire-extinguishing liquid in the event of a fire.

Even when the upper case 12 is applied, the fire extinguishing case 13 is filled with the fire-extinguishing liquid in the event of a fire so that the battery cell assembly 11 is submerged in the fire-extinguishing liquid.

When the upper case 12 is applied, a vapor discharge valve 12a for discharging vapor generated inside the upper case 12 and the fire extinguishing case 13 is provided at the upper case 12 for prevention of explosion.

Furthermore, the temperature sensor 31 and the off-gas sensor 32 may be provided at the upper case 12.

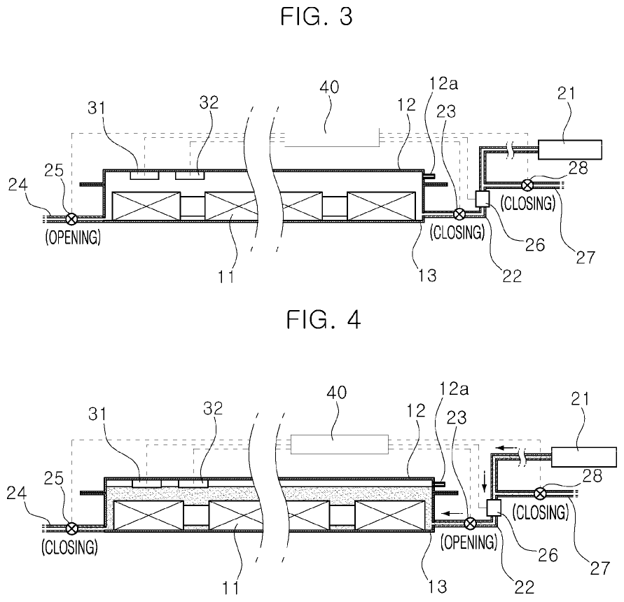

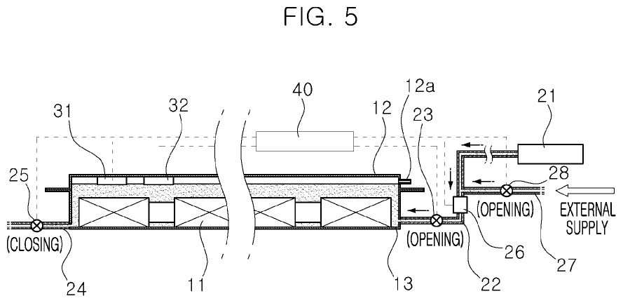

Furthermore, regardless of the presence or absence of the upper case 12, when a fire is detected, the fire-extinguishing liquid is supplied into the fire extinguishing case 13 to extinguish the fire. FIG. 3, FIG. 4, and FIG. 5 show a process of supplying the fire-extinguishing liquid when the upper case 12 is applied. Even when the upper case 12 is not present, the fire-extinguishing liquid is supplied in a same way as the upper case 12 is applied.

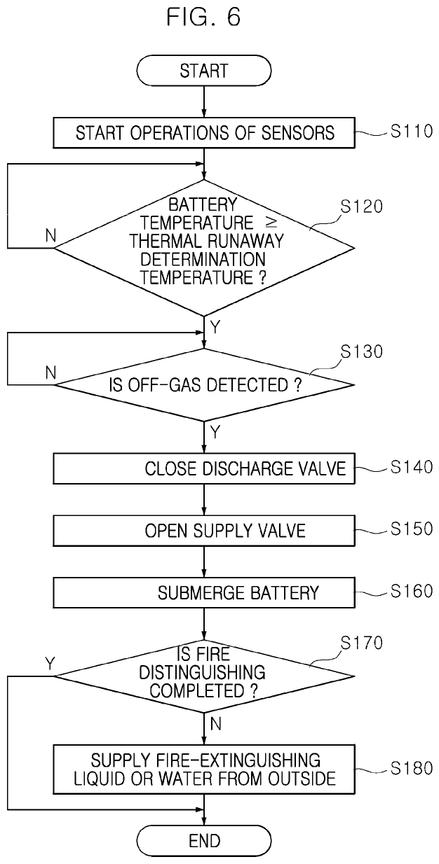

FIG. 6 shows a method of extinguishing a fire of a high voltage battery for a vehicle according to an exemplary embodiment of the present disclosure.

The method of extinguishing a fire of a high voltage battery for a vehicle according to an exemplary embodiment of the present disclosure is performed using the above-described system for extinguishing a fire of a high voltage battery for a vehicle.

In a sensor start-up step S110, the temperature sensor 31 and the off-gas sensor 32 start to operate, and an output value of the temperature sensor 31 measuring a temperature of the battery cell assembly 11 and an output value of the off-gas sensor 32 detecting an off-gas generated from the battery cell assembly 11 are input to the controller 40.

When the output values start to be input from the temperature sensor 31 and the off-gas sensor 32 to the controller 40, the controller 40 monitors the output values to determine whether a fire occurs in the battery cell assembly 11.

In a battery temperature comparison step S120, the controller 40 is configured to determine whether a temperature of the battery cell assembly 11 is higher than or equal to a preset thermal runaway temperature indicating that a thermal runaway occurs in the battery cell assembly 11. The temperature sensor 31 continuously outputs the temperature of the battery cell assembly 11, which is measured by the temperature sensor 31, to the controller 40. The controller 40 compares whether the temperature input from the temperature sensor 31 is higher than or equal to the preset thermal runaway temperature indicating that a thermal runaway occurs in the battery cell assembly 11 due to a fire. When the temperature of the battery cell assembly 11 is higher than or equal to the thermal runaway temperature, it may be determined that the fire occurs in the battery cell assembly 11. When it is determined that the temperature of the battery cell assembly 11 is not higher than or equal to the thermal runaway temperature in the battery temperature comparison step S120, the battery temperature comparison step S120 is repeatedly performed.

In an off-gas detecting step S130, the controller 40 is configured to determine whether an off-gas is generated from the battery cell assembly 11. When the off-gas is detected based on the output value of the off-gas sensor 32, the controller 40 is configured to determine that the fire occurs in the battery cell assembly 11. When the off-gas is not detected in the off-gas detecting step S130, the off-gas detecting step S130 is repeatedly performed.

The controller 40 finally is configured to determine that the fire occurs in the battery cell assembly 11 only when the battery temperature comparison step S120 and the off-gas detecting step S130 are satisfied.

Furthermore, in the battery temperature comparison step S120 and the off-gas detecting step S130, the off-gas detecting step S130 may be performed first, and the battery temperature comparison step S120 may be performed after the off-gas detecting step S130.

In an exemplary embodiment of the present disclosure, the controller 40 finally is configured to determine that the fire occurs in the battery cell assembly 11 when the battery temperature comparison step S120 or the off-gas detecting step S130 are satisfied.

In a discharge valve closing step S140, when the controller 40 detects the fire of the battery cell assembly 11, the controller 40 closes the discharge valve 25 provided at the discharge pipe 24. Because the discharge valve 25 is closed, when the fire-extinguishing liquid is supplied to the fire extinguishing case 13, 20, it is possible to prevent the fire-extinguishing liquid from being discharged through the discharge pipe 24.

In a supply valve opening step S150, when the controller 40 detects the fire of the battery cell assembly 11, the controller 40 opens the supply valve 23 provided at the supply pipe 22. When the supply valve 23 is opened, the fire-extinguishing liquid of the fire-extinguishing liquid tank 21 is supplied to the fire extinguishing case 13, 20 through the supply pipe 22. Because the discharge valve 25 is closed and the fire extinguishing case 13, 20 accommodates the battery cell assembly 11, when the supply valve 23 is opened, a liquid level of the fire-extinguishing liquid gradually increases in the fire extinguishing case 13, 20. In the supply valve opening step S150, the controller 40 opens the supply valve 23 as well as starts to drive the pump 26 provided at the supply pipe 22.

For fire extinguishing of the battery cell assembly 11 in which the fire occurs, the fire-extinguishing liquid may be supplied to the fire extinguishing case 13, 20 to rapidly cool the battery cell assembly 11, extinguishing the fire at an early stage.

In a battery submerging step S160, the liquid level of the fire-extinguishing liquid is higher than a top surface of the battery cell assembly 11 so that the battery cell assembly 11 is completely submerged in the fire-extinguishing liquid. The battery cell assembly 11 is submerged in the fire-extinguishing liquid, and thus the fire of the battery cell assembly 11 may be extinguished by the fire-extinguishing liquid without proceeding any further.

After the battery cell assembly 11 is submerged in the fire-extinguishing liquid, the controller 40 is configured to perform a fire extinguishing completion determining step S170 of continuously determining whether the fire of the battery cell assembly 11 is extinguished. As described above, the controller 40 is configured to determine whether the fire proceeds in the battery cell assembly 11 or is extinguished based on the output values of the temperature sensor 31 and the off-gas sensor 32.

In an exemplary embodiment of the present disclosure, the controller 40 is configured to determine whether the fire in the battery cell assembly 11 is extinguished when the temperature of the battery cell assembly 11 detected the temperature sensor 31 is lower than the thermal runaway temperature and the off-gas is not detected by the off-gas sensor 32.

When it is determined that the fire extinguishing is completed in the fire extinguishing completion determining step S170, the logic ends.

However, when it is determined that the fire is not extinguished in the fire extinguishing completion determining step S170, an external supplying step S180 is performed to additionally supply a fire-extinguishing liquid or water from the outside. The controller 40 opens the external supply valve 28 to additionally supply the fire-extinguishing liquid or water to the fire extinguishing case 13, 20 from the outside.

In accordance with a system and a method for extinguishing a fire of a high voltage battery for a vehicle, which include the above-described configuration, when a fire of a high voltage battery is detected, a fire-extinguishing liquid is supplied inside a fire extinguishing case in which the high voltage battery is accommodated, and thus the high voltage battery is submerged in the fire-extinguishing liquid so that the fire of the high voltage battery may be extinguished.

Furthermore, when the fire-extinguishing liquid is insufficient, a fire-extinguishing liquid or water may be additionally supplied from the outside thereof so that the fire of the high voltage battery may be rapidly extinguished.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular form may also include a plural form. The expression “at least one (or one or more) of A, B, and C” may include at least one of all combinations which may include combining A, B, and C.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

A singular expression includes a plural expression unless the context clearly indicates otherwise.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system for extinguishing a fire of a high voltage battery, the system comprising:
a battery cell assembly;
a fire extinguishing case to accommodate the battery cell assembly therein;
a fire-extinguishing liquid tank connected to the fire extinguishing case, wherein a fire-extinguishing liquid is stored in the fire-extinguishing liquid tank:
a supply valve provided between the fire-extinguishing liquid tank and the fire extinguishing case and configured to supply or block the fire-extinguishing liquid from the fire-extinguishing liquid tank to the fire extinguishing case; and
a controller electrically connected to the supply valve and configured to open the supply valve to supply the fire-extinguishing liquid to the fire extinguishing case when the controller concludes that the fire occurs in the battery cell assembly.

2. The system of claim 1,
wherein a supply pipe is provided to connect the fire-extinguishing liquid tank to the fire extinguishing case so that the fire-extinguishing liquid is supplied from the fire-extinguishing liquid tank to the fire extinguishing case, and
wherein the supply valve is provided at the supply pipe.

3. The system of claim 2, wherein a pump is provided at the supply pipe to pressurize the fire-extinguishing liquid and supply the fire-extinguishing liquid to the fire extinguishing case.

4. The system of claim 2, wherein the supply pipe is connected to an external supply line which supplies a fire-extinguishing liquid or water from the outside thereof, between the supply valve and the fire-extinguishing liquid tank.

5. The system of claim 4, further including:
an external supply valve mounted on the external supply line,
wherein the external supply valve is controlled by the controller to open or close the external supply valve.

6. The system of claim 1, further including a discharge pipe and a discharge valve,
wherein the discharge pipe is connected to the fire extinguishing case to discharge a liquid inside the fire extinguishing case to the outside of the fire extinguishing case,
wherein the discharge valve is provided at the discharge pipe, and
wherein the controller is configured to close the discharge valve when the fire of the battery cell assembly is detected.

7. The system of claim 6, wherein each of the supply valve and the discharge valve includes a check valve.

8. The system of claim 1, further including:
a sensor configured to detect the fire of the battery cell assembly and output a fire detection signal to the controller.

9. The system of claim 8, wherein the sensor includes a temperature sensor configured for measuring a temperature of the battery cell assembly.

10. The system of claim 9, wherein when the temperature of the battery cell assembly is higher than or equal to a thermal runaway temperature, the controller is configured to conclude that the fire occurs in the battery cell assembly.

11. The system of claim 8, wherein the sensor includes an off-gas sensor configured to detect a gas generated from the battery cell assembly during thermal runaway.

12. The system of claim 1, further including:
an upper case which closes an upper portion of the fire extinguishing case.

13. A method of extinguishing a fire of a high voltage battery for a vehicle, the method comprising:
a battery temperature comparison step of determining, by a controller, whether a temperature of a battery cell assembly is higher than or equal to a thermal runaway temperature;
an off-gas detecting step of determining, by the controller, whether an off-gas is generated from the battery cell assembly;
a supply valve opening step of opening, by the controller, a supply valve provided between a fire-extinguishing liquid tank which accommodates a fire-extinguishing liquid and a fire extinguishing case which accommodates the battery cell assembly, when the controller concludes that the temperature of the battery cell assembly is higher than or equal to the thermal runaway temperature or the off-gas is generated from the battery cell assembly; and
a battery submerging step of increasing, by the controller, a liquid level of the fire-extinguishing liquid to be higher than a top surface of the battery cell assembly, when the controller concludes that the temperature of the battery cell assembly is higher than or equal to the thermal runaway temperature or the off-gas is generated from the battery cell assembly.

14. The method of claim 13, further including:
before the battery temperature comparison step, a sensor start-up step of inputting an output value of a temperature sensor configured for measuring the temperature of the battery cell assembly and an output value of an off-gas sensor configured to detect the off-gas generated from the battery cell assembly to the controller.

15. The method of claim 13, wherein, in the battery temperature comparison step and the off-gas detecting step, the off-gas detecting step is performed first, and then the battery temperature comparison step is performed.

16. The method of claim 13, further including:
before the supply valve opening step, a discharge valve closing step of closing, by the controller, a discharge valve connected to the fire extinguishing case.

17. The method of claim 14, wherein, when the controller concludes that the temperature of the battery cell assembly is not higher than or equal to the thermal runaway temperature in the battery temperature comparison step, the battery temperature comparison step is repeatedly performed.

18. The method of claim 14, wherein, when the generation of the off-gas is not detected in the off-gas detecting step, the off-gas detecting step is repeatedly performed.

19. The method of claim 13, further including:
after the battery submerging step, a fire extinguishing completion determining step of determining whether the fire of the battery cell assembly is extinguished; and
when the controller concludes that the fire of the battery cell assembly is not extinguished, an external supplying step of additionally supplying a fire-extinguishing liquid or water from the outside to the fire extinguishing case.

20. The method of claim 13, wherein the controller includes:
a processor; and
a non-transitory storage medium on which a program for performing the method of claim 13 and for being executed by the processor is recorded.
